(19) United States
(12) Patent Application Publication
(10) Pub. No.: US 2009/0231210 A1
(43) Pub. Date: Sep. 17, 2009

(54) PORTABLE DEVICE AND BATTERY

(75) Inventor: Omid SOTOUDEH, Upplands Vasby (SE)

Correspondence Address: HARRITY & HARRITY, LLP, 11350 RANDOM HILLS ROAD, SUITE 600, FAIRFAX, VA, 22030, US

(73) Assignee: Sony Ericsson Mobile Communications AB, Lund (SE)

(21) Appl. No.: 12/047,490

(22) Filed: Mar. 13, 2008

(51) Int. Cl. H01Q 1/24

(52) U.S. Cl. 343/702

(57) ABSTRACT

A portable device is provided with an antenna and a printed wiring board (PWB) to which the antenna is connected and a battery. The antenna includes at least one antenna element that is located remotely from the PWB on/in a substantially non-electrically-conducting component of the portable device, or on/in a non-electrically-conducting part of a component of the portable device, and arranged to be connected to the PWB via at least one capacitive and/or inductive coupling element, such as a strip line.

### TECHNICAL FIELD

The present invention relates generally to a portable device that includes an antenna and a battery for use in the portable device.

### BACKGROUND OF THE INVENTION

An antenna is a transducer designed to transmit and/or receive radio, television, microwave, telephone and radar signals. That is, an antenna converts electrical currents of a particular frequency into electromagnetic waves and vice versa. Physically, an antenna is an arrangement of one or more electrical conductors that are configured to generate a radiating electromagnetic field in response to an applied alternating voltage and the associated alternating electric current, or that can be placed in an electromagnetic field so that the field will induce an alternating current in the antenna and a voltage between its terminals, i.e., a transceiver.

Portable wireless communication electronic devices, such as mobile telephones, typically include an antenna that is connected to electrically conducting tracks or contacts on a printed wiring board (PWB) by soldering or welding. Many portable devices include a number of these antennas to provide cellular system communication functionality, for example, GSM or WCDMA communication functionality and non-cellular system communication functionality, for example, Bluetooth, W-LAN or FM-Radio communication functionality. The number of supported systems directly increases the number of dedicated antennas, which often results in a substantial increase in the component part count and consequently the size and cost of the portable electronic devices.

Manufacturers of such electronic devices are under constant commercial restraints to reduce the physical size, weight, and cost of the devices and improve their electrical performance. Antennas such as FM antennas and other low efficiency antennas, such as a Digital Video Broadcasting-Handheld (DVB-H) or Global Positioning System (GPS) antennas are therefore often not included in portable devices since they have a low gain, they interfere with the transmission and/or reception of signals by other more prioritized antennas in the portable device and require space that could instead be occupied by a more prioritized antenna.

### SUMMARY OF THE INVENTION

Embodiments of the present invention provide an improved portable device including an antenna and a printed wiring board (PWB) to which the antenna is connected.

In an exemplary portable device, the antenna includes at least one antenna element that is located remotely from the PWB on/in a substantially non-electrically-conducting component of the portable device, or on/in a substantially non-electrically-conducting part of a component of the portable device, and arranged to be connected to the PWB via at least one capacitive and/or inductive coupling element.

A capacitive and/or inductive coupling element is namely connected between the antenna element and a ground point or plane on a PWB, and thereby constitutes an LC load, to enable the antenna element to realize a particular resonant frequency and consequently transmit signals within a particular frequency band when the antenna element is in use. The capacitive and/or inductive coupling element may be arranged to be fixedly attached to the PWB or antenna element or fixedly attached to both by any conventional means, such as soldering or spot welding. Alternatively, the capacitive and/or inductive coupling element may be non-fixedly attached to both an antenna element and a PWB.

A capacitive and/or inductive coupling element may for example be a strip line. A strip line comprises a flat strip of metal which is sandwiched in a dielectric substrate between two parallel ground planes. The width of the strip and the thickness and relative permittivity of the dielectric substrate determine the characteristic impedance of the strip which acts as a transmission line, (i.e., a medium for conveying signal energy to and from the antenna element). A capacitive and/or inductive coupling element may be of any length, such as up to 5 mm long, or up to 3 cm long, or longer, it may be of any design and its relative permittivity may be selected as desired.

It should be noted that the antenna may comprise a plurality of antenna elements that are all located remotely from the PWB on/in one or more substantially non-electrically-conducting components or component parts of the portable device. Alternatively, the antenna may comprise a plurality of antenna elements, one or more of which are mounted directly on a PWB.

It should be noted that if a component of a portable device comprises an electrically conducting material, such as metal, an antenna element may be provided on/in a substantially non-electrically-conducting coating or layer, which is in turn attached or applied to the component or arranged to be supported thereby.

The expression “located remotely from a PWB” is intended to mean that neither the antenna element nor the substantially non-electrically-conducting component or component part of the portable device on which the antenna element is located is mounted directly on a PWB.

The expression “substantially non-electrically-conducting component” is intended to mean any material that is considered to be an electric insulator, such as plastic, ceramic, glass, porcelain, composite polymer material, fibre-reinforced plastic, rubber, or any other suitable material having a relative dielectric constant (∈ᵣ) greater than one, and up to twenty or more.

The expression “printed wiring board”, or “PWB” (also called printed circuit board (PCB)), as used in this document is intended to mean any flexible or non-flexible, planar or non-planar, substantially non-electrically-conducting substrate that is used to mechanically support at least one microchip or other electronic component, and/or to electrically connect components supported thereon and/or connected thereto using conductive pathways etched/printed/engraved or otherwise provided thereon.

The expression “arranged to be connected” in the expression “at least one antenna element that is arranged to be connected to the PWB via at least one capacitive and/or inductive coupling element” is intended to mean that an antenna element may be fixedly connected to the PWB or, alternatively, an antenna element may be non-fixedly connected to the PWB so that it can be connected and disconnected as desired.

According to an embodiment of the invention the portable device includes a battery compartment and at least one antenna element, i.e., at least one antenna element of the at least one antenna element constituting the antenna, is located in a battery lid of the battery compartment, i.e., incorporated in the material constituting the battery lid, or on a surface of the battery lid.

According to another embodiment of the invention the portable device includes a battery and at least one antenna element is located on a surface of the battery.

According to a further embodiment of the invention the portable device includes a casing, such as an outer casing, and at least one antenna element is located in/on the casing.

According to an embodiment of the invention the antenna is arranged to transmit and/or receive frequencies below the Global System for Mobile communications (GSM) frequency band frequencies. GSM frequency bands are the radio spectrum frequencies designated by the International Telecommunication Union (ITU) for the operation of GSM for mobile phones. There are fourteen bands defined in 3GPP TS 45.005, which succeeded 3GPP TS 05.05, ranging from uplink frequencies of 380.2 to 1910.0 MHz and downlink frequencies of 390.2 to 1990.0 MHz. A mobile device may thereby incorporate a low frequency antenna in a cost- and space-efficient manner.

According to an embodiment of the invention the antenna is a frequency modulation (FM), Digital Video Broadcasting-Handheld (DVB-H) or Global Positioning System (GPS) antenna.

According to an embodiment of the invention at least one antenna element is a concentric open loop antenna element. The antenna may comprise a plurality of concentric loop antenna elements all having the same feed point. It should be noted that the at least one antenna element may however comprise any arrangement of one or more electrical conductors.

According to another embodiment of the invention the portable device comprises a one or more of the following: a telephone, media player, Personal Communications System (PCS) terminal, Personal Data Assistant (PDA), laptop computer, palmtop receiver, camera, television, radar or any appliance that includes a transducer designed to transmit and/or receive radio, television, microwave, telephone and/or radar signals. The portable device according to the present invention is however intended for use particularly, but not exclusively for high frequency radio equipment.

The present invention also concerns a battery for use in a portable device according to any of the embodiments of the invention, whereby the battery comprises at least one antenna element that is arranged to be connected to a PWB of the portable device via at least one capacitive and/or inductive coupling element. The battery may comprise at least one antenna element only (i.e. without a capacitive and/or inductive coupling element, in which case the latter is provide on a PWB inside the portable device), or at least one antenna element and at least one capacitive and/or inductive coupling element that is arranged to be connected to a PWB of the portable device. It should be noted that a battery may be arranged to have different antenna elements on different surfaces thereof, whereby a particular antenna element for a particular application may be selected by inserting the battery into a portable device in a particular way, for example with one of its sides facing a PWB, so that the desired antenna element can then be connected to a PWB.

It should be noted that when an antenna element is included in a small portable radio communication device, such as a mobile phone, it only partly contributes to the transmission or reception of the radio waves transmitted or received by the device. Other large, electrically conductive components of the device, such as its chassis, its battery or a PWB also influence the transmission and/or reception of radio signals. The antenna element(s) is/are capacitively and/or inductively coupled to such so-called mass blocks of a device in such a way that the complete antenna (i.e. the antenna elements and the mass blocks) is provided with the desired impedance. Consequently, the component that is normally considered to be an “antenna” in fact functions as an exciter for such mass blocks and has therefore been designated an “antenna element” rather than an “antenna”. The expression “antenna element” in this document is however intended to include components that may be considered to be “antennas” rather than “antenna elements.”

### BRIEF DESCRIPTION OF THE DRAWINGS

The present invention will hereinafter be further explained by means of non-limiting examples with reference to the appended schematic figures wherein:

FIG. 1 shows the front and rear side of a portable device according to an embodiment of the invention;

FIG. 2 shows a cross section of a portable device according to an embodiment of the invention;

FIG. 3 shows an antenna element, capacitive and/or inductive coupling element and PWB of a mobile device according to an embodiment of the invention; and

FIG. 4 shows an antenna element according to an embodiment of the invention.

It should be noted that the drawings have not been drawn to scale and that the dimensions of certain features have been exaggerated for the sake of clarity.

### DETAILED DESCRIPTION OF EMBODIMENTS

FIG. 1 shows the front (f) and rear (r) side of a portable device 10 according to an embodiment of the invention, namely a cellular phone in the illustrated embodiment. Portable device 10 may include a battery 12, accommodated in a battery compartment including a battery lid or removable cover 14, made from plastic for example, and an outer casing or housing 16.

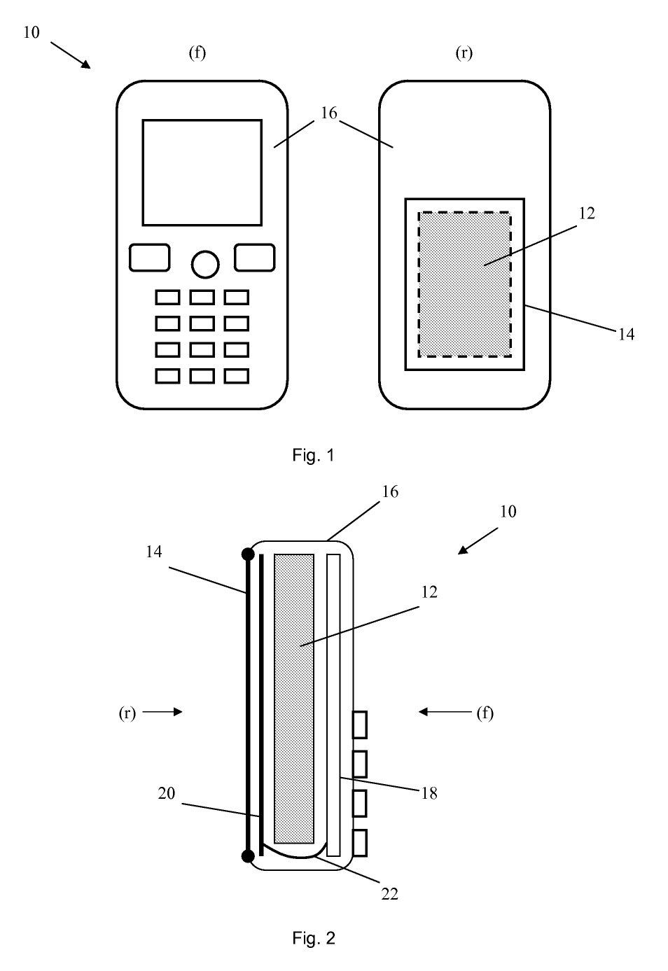

FIG. 2 shows a cross section of portable device 10 illustrated in FIG. 1. Portable device 10 may include a printed wiring board (PWB) 18 and an antenna (not shown) connected to PWB 18. The antenna may include an antenna element 20 that is located remotely from the PWB on/in a substantially non-electrically-conducting component of portable device 10, for example, on the inside surface of battery lid 14 in the illustrated embodiment. Antenna element 20 could alternatively or additionally be located on the inside or outside surface of substantially non-electrically-conducting outer casing 16, and/or inside substantially non-electrically-conducting outer casing 16, i.e., incorporated within (i.e., integral with) the material of outer casing 16, inside substantially non-electrically-conducting battery lid 14, and/or on substantially non-electrically-conducting surface of battery 12.

Antenna element 20 may be arranged to be connected to PWB 18 via a capacitive and/or inductive coupling element 22, such as a strip line. Capacitive and/or inductive coupling element 22 need not necessarily extend through portable device 10 as shown in FIG. 2, but may be of any length and be arranged to extend in any manner through portable device 10.

Antenna element 20 may constitute at least part of an antenna that is arranged to transmit and/or receive frequencies below the Global System for Mobile communications (GSM) frequency band frequencies and is for example a frequency modulation (FM), Digital Video Broadcasting-Handheld (DVB-H) or Global Positioning System (GPS) antenna. It should be noted that portable device 10, according to the present invention, may, of course, include a plurality of antennas, mounted directly on its PWB(s) or arranged in the manner according to the present invention.

FIG. 3 shows antenna element 20, capacitive and/or inductive coupling element 22, and PWB 18 of a mobile device according to an embodiment of the invention. Antenna element 20 is exemplified as a concentric open loop antenna element. The conductive pathway of antenna element 20 may be etched/printed/engraved or otherwise provided on a substantially non-electrically-conducting component (e.g., battery lid 14) or component part of a portable device.

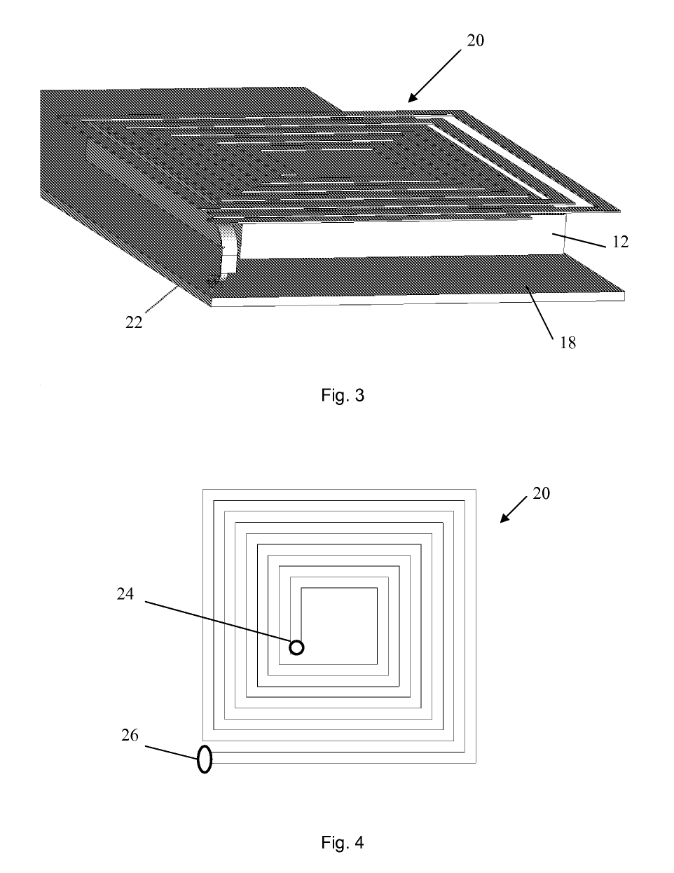

FIG. 4 shows concentric open loop antenna element 20 as provided on/inside a substantially non-electrically-conducting component, or on/inside a substantially non-electrically-conducting part of a component of a portable device. Antenna element 20 includes a feed point 24 for connection to a feed line, i.e., a medium for conveying a signal from a signal source to antenna element 20 and a point 26 to which a capacitive and/or inductive coupling element (not shown) may be fixedly or non-fixedly attached to connect antenna element 20 to a ground point or ground plane on a PWB of mobile device. An antenna may, of course, include a plurality of such concentric loop antenna elements 20 all having the same feed point 24.

Further modifications of the invention within the scope of the claims would be apparent to a skilled person. For example, a portable device according to the invention may include circuitry to enable a user to connect or disconnect a particular antenna and thereby select the frequency band of transmitted and/or received signals and the number of communication channels in use.

What is claimed is:

1. A portable device comprising:
an antenna;
a substantially non-electrically-conducting component; and
a printed wiring board (PWB) to connect to the antenna, wherein said antenna includes at least one antenna element to be remotely disposed from said PWB on the substantially non-electrically-conducting component, and is arranged to connect to the PWB via at least one capacitive or inductive coupling element.

2. The portable device of claim 1, further comprising:
a battery compartment, wherein said at least one antenna element is located in a cover for said battery compartment or on a surface of the cover.

3. The portable device of claim 1, further comprising:
a battery, wherein said at least one antenna element is located on a surface of said battery.

4. The portable device of claim 1, further comprising:
a casing, wherein said at least one antenna element is located in said casing or on a surface of said casing.

5. The portable device of claim 1, wherein said antenna is arranged to operate in frequencies below the Global System for Mobile communications (GSM) frequency band frequencies.

6. The portable device of claim 1, wherein said antenna is a frequency modulation (FM), Digital Video Broadcasting-Handheld (DVB-H) or Global Positioning System (GPS) antenna.

7. The portable device of claim 1, wherein the at least one antenna element is a concentric open loop antenna element.

8. The portable device of claim 1, wherein said antenna comprises a plurality of concentric loop antenna elements having a common feed point.

9. A battery for use in a portable device, comprising:
at least one antenna element to be remotely disposed from said PWB on the substantially non-electrically-conducting component, and is arranged to connect to the PWB via at least one capacitive or inductive coupling element.

10. A portable device comprising:
an antenna; and
a printed wiring board (PWB) connected to the antenna, wherein said antenna includes at least one antenna element to be remotely disposed from said PWB on a substantially non-electrically-conducting portion of a component of the portable device, and is arranged to connect to the PWB via at least one capacitive or inductive coupling element.

11. The portable device of claim 10, further comprising:
a battery compartment, wherein said at least one antenna element is located in a cover of said battery compartment or on a surface of said cover.

12. The portable device of claim 10, further comprising:
a battery, wherein said at least one antenna element is located on a surface of said battery.

13. The portable device of claim 10, further comprising:
a casing, wherein said at least one antenna element is located in said casing or on a surface of said casing.

14. The portable device of claim 10, wherein said antenna is arranged to operate in frequencies below the Global System for Mobile communications (GSM) frequency band frequencies.

15. The portable device of claim 10, wherein said antenna is a frequency modulation (FM), Digital Video Broadcasting-Handheld (DVB-H) or Global Positioning System (GPS) antenna.

16. The portable device of claim 10, wherein the at least one antenna element is a concentric open loop antenna element.

17. The portable device of claim 10, wherein said antenna comprises a plurality of concentric loop antenna elements having a common feed point.
